(19) United States
(12) Patent Application Publication
(10) Pub. No.: US 2021/0121934 A1
(43) Pub. Date: Apr. 29, 2021

(54) Method and Device for Continuously Forming Wood/Bamboo Molded Hollow Wallboard with Embedded Reinforcing Ribs

(71) Applicant: Zhejiang Academy of Forestry, Zhejiang (CN)

(72) Inventors: Lequn Liu, Zhejiang (CN); Fangcheng Liu, Zhejiang (CN)

(73) Assignee: Zhejiang Academy of Forestry, Zhejiang (CN)

(21) Appl. No.: 17/030,472

(22) Filed: Sep. 24, 2020

(30) Foreign Application Priority Data
Oct. 25, 2019 (CN) 201911022139.5

(51) Int. Cl. B21D 28/28; B27N 5/02

(52) U.S. Cl. CPC B21D 28/28; B27N 5/02

(57) ABSTRACT

A device and method for forming a hollow wallboard, in particular, for continuously forming a wood/bamboo molded hollow wallboard with embedded reinforcing ribs, feature a simple process, with high production efficiency, and continuous production at low production cost. The method for continuously forming a wood/bamboo molded hollow wallboard with embedded reinforcing ribs includes: 1) driving a punch in a molding cavity by an actuating mechanism to move up and down in a straight line along vertical guide rails, so that the punch moves relative to a plurality of inner molding tubes and a plurality of reinforcing ribs which are vertically provided in the molding cavity and are in a movable fit with the punch; and allowing a heating mechanism to heat both an inner wall of the molding cavity and a wall of the inner molding tubes.

### CROSS-REFERENCE TO RELATER APPLICATIONS

This application claims priority to CN Application No. 201911022139.5, filed on Oct. 25, 2019, the disclosure of which is incorporated herein by reference.

### BACKGROUND

The present invention relates to a device and method for forming a hollow wallboard, in particular to a device and method for continuously forming a wood/bamboo molded hollow wallboard with embedded reinforcing ribs.

Wooden buildings are the most important architectural form in the long history of Chinese architecture. However, since the 1960s, due to the lack of timber caused by the wanton felling of forests coupled with the wrong concept, wooden buildings have been gradually replaced by reinforced concrete buildings. At present, wooden buildings in developed countries generally account for more than 45% of the total construction. In North American countries, the proportion has reached more than 85%. These countries have a significant advantage in the development of wooden buildings, that is, they have rich forest resources. With the rapid development of economy, Chinese people are increasingly pursuing the beautiful and comfortable natural living environment, and wooden buildings are rapidly reemerging again. However, the timber resources are still in serious shortage, and it is an urgent task in the field of construction to develop a wallboard with similar properties to replace the wooden wallboard.

Wood/bamboo molded hollow board (including artificial hollow particleboard) has the advantages of high transverse strength, stable thickness, low density, heat insulation, sound insulation and material saving. It is an alternative to replace the wooden wallboard of wooden buildings. However, the existing production process has inherent defects. The strength in the punching direction (longitudinal direction) is low, and the dimensional stability is poor. It is impossible to produce boards with a thickness of more than 5 cm, and it needs to cover with a wood/bamboo veneer. As a result, the existing production process has high production cost and low production efficiency. It severely restricts the application of the wood/bamboo molded hollow board, and the board can only be used as a core board for various wooden doors although it has superior properties. In order to enhance the longitudinal compressive strength and dimensional stability of the wood/bamboo molded hollow board, reinforcing ribs are added to the wood/bamboo molded hollow board. Currently, there are two methods for setting reinforcing ribs. The first method is to define a plurality of holes during the molding of the wood/bamboo molded hollow board, and penetrate reinforcing ribs into the holes one by one and bond them to the wall of the holes by using an adhesive after the molding is completed. The second method is to use a flat platen pressing method to prepare the molded hollow board, and place reinforcing ribs at the same time of molding. Although these methods improve the longitudinal strength and dimensional stability of the board, they have low production efficiency and high production cost due to secondary processing and intermittent production. In addition, they still cannot produce boards with a thickness of more than 5 cm in accordance with the requirements of specifications for the wallboard of wooden buildings, or realize the industrial production of the wood/bamboo hollow board.

### SUMMARY

This invention relates to In order to overcome the shortcomings of the prior art mentioned in the background, an objective of the present invention is to provide a device and method for continuously forming a wood/bamboo molded hollow wallboard with embedded reinforcing ribs. The forming device and method effectively improve the compressive strength of the wood/bamboo molded hollow wallboard in a punching direction, improve the dimensional stability of the board, and realize the balance of isotropic properties and shape stability of the board. The forming device and method feature simple process, high production efficiency, continuous production and low production cost.

The technical solution of the present invention is as follows:

A method for continuously forming a wood/bamboo molded hollow wallboard with embedded reinforcing ribs includes the following steps:

1) driving a punch in a molding cavity by an actuating mechanism to move up and down in a straight line along vertical guide rails, so that the punch moves relative to a plurality of inner molding tubes and a plurality of reinforcing ribs which are vertically provided in the molding cavity and are in a movable fit with the punch; allowing a heating mechanism to heat both an inner wall of the molding cavity and a wall of the inner molding tubes;

2) moving the punch upwards for a distance (preferably 20-80 mm) away from an upper opening on a molding plate to open a top inlet of the molding cavity; enabling a feeding device to evenly feed wood/bamboo particles accompanied by glue into the molding cavity through the top inlet, wherein the wood/bamboo particles are supported by a bottom plate after falling into the molding cavity;

3) driving the punch by the actuating mechanism to move downwards and enter the molding cavity to punch the fed wood/bamboo particles, so that the wood/bamboo particles and the reinforcing ribs are combined tightly into a board blank to be heated in the molding cavity; forming holes penetrating through the board blank from top to bottom by using the inner molding tubes; moving the board blank together with the bottom plate connected to the bottom of the reinforcing ribs downwards for a plurality of distances (preferably 10-50 mm);

4) moving the punch upwards again for a distance away from the upper opening of the molding cavity to open the top inlet of the molding cavity again; enabling the feeding device to evenly feed the wood/bamboo particles accompanied by the glue into the molding cavity through the top inlet, wherein the wood/bamboo particles are laid on an upper part of the board blank formed in the above step after falling into the molding cavity; allowing the punch to punch the fed particles while the formed board blank is heated outside and inside simultaneously at high temperature by the wall of the molding cavity and the wall of the inner molding tubes, so that the glue can quickly solidifies every time the board blank is subjected to mobile punching;

5) repeating steps 3) and 4) to perform continuous cyclic operations, that is feeding, punching and heating the wood/bamboo particles to form a continuously formed board blank; gradually moving the board blank downwards out of the molding cavity, to obtain a finished wood/bamboo molded hollow wallboard.

The molding cavity is enclosed by two molding plates keeping a distance in a thickness direction of the cavity and two thickness gauges provided at both ends of the cavity in a width direction; the molding cavity is provided with an opening on the top and at the bottom, respectively.

The bottom plate is pulled by the plurality of reinforcing ribs; the plurality of reinforcing ribs are respectively released by a release mechanism provided at the top of a device, and then pass vertically downward through the punch to connect the bottom plate.

The plurality of reinforcing ribs are evenly embedded in the board blank, and each reinforcing rib is kept at a distance from the holes and an outer surface of the board blank.

Top ends of the plurality of inner molding tubes are fixed on a beam on an upper part of the frame; the vertical guide rails are provided on an inner wall of pillars on two ends of the frame.

The actuating mechanism is a crank and slider mechanism driven by a motor through a pulley mechanism; the crank is a connecting rod eccentrically hinged on a punching flywheel.

A device for continuously forming a wood/bamboo molded hollow wallboard with embedded reinforcing ribs, comprising a molding cavity, a plurality of inner molding tubes and a punch, wherein the molding cavity is provided vertically, and has a rectangular cross section; the molding cavity is provided with an opening on the top and at the bottom, respectively; the plurality of inner molding tubes are vertically arranged in a straight line in the molding cavity; top ends of the inner molding tubes are fixed on a frame on an upper part of a frame; the punch is adapted to a shape of the cross section of the molding cavity, and is able to be driven by an actuating mechanism to move up and down in the molding cavity; the molding cavity is enclosed by two molding plates keeping a parallel distance in a thickness direction of the cavity and two thickness gauges provided at both sides of the cavity in a width direction; the punch is in a movable fit with the inner molding tubes through a plurality of sliding holes vertically provided thereon; a heating system is embedded in the molding plates and the inner molding tubes; the frame is further provided with a feeding device for feeding wood/bamboo particles into the molding cavity;

a bottom plate is further horizontally provided under the punch; the bottom plate is able to move up and down in the molding cavity; a peripheral shape of the bottom plate is adapted to the cross-sectional shape of the molding cavity; the bottom plate is provided with a plurality of sliding holes that are in a slidable fit with the inner molding tubes; the bottom plate and the punch are respectively provided with a plurality of through holes; the plurality of reinforcing ribs pass through the through holes on the punch from top to bottom, and then are fixed on the bottom plate in a single direction;

the plurality of reinforcing ribs are respectively gradually released by a release mechanism provided on the top of the frame.

A wall surface of the molding cavity is provided with a plurality of vertical protrusions, which correspond to grooves on a surface of the wood/bamboo molded hollow wallboard to increase a surface decoration effect of the wood/bamboo molded hollow wallboard.

Two ends of the punch are vertically slidably positioned on pillars on the frame through a vertical guide rail mechanism; the guide rail mechanism comprises a plurality of vertical guide rails provided on the pillars at two sides of the frame and a plurality of sliders fixed on a periphery of the punch and fit with the vertical guide rails.

Two ends of the punch in a length direction respectively extend out of the frame to hinge with a bottom end of a connecting rod that is eccentrically hinged on a punching flywheel; thus, rotational kinetic energy is converted into linear punching kinetic energy to punch the wood/bamboo particles fed into the molding cavity.

The present invention has the following beneficial effects. In the wood/bamboo molded hollow wallboard produced by the present invention, reinforcing ribs and a molded hollow wallboard are integrated simultaneously and continuously. Thus, the reinforcing ribs are tightly meshed and firmly connected with the molded hollow wallboard, which greatly improves the longitudinal strength (According to measurement, the strength can be increased by an order of magnitude) and dimensional stability of the wood/bamboo molded hollow wallboard; The continuous production process can produce large wallboards of any size to meet the needs of different building volumes as long as the width dimension is designed and manufactured sufficiently large. Meanwhile, this process omits the complicated procedures of secondary processing and intermittent production, greatly improving the production efficiency and significantly reducing the production cost so as to obtain a novel wallboard that has a stable shape and balanced properties meeting the requirements of specifications for the wallboard of fabricated wooden buildings. And it can be produced on a large scale, large size, and rapid industrialization; The novel wallboard has the characteristics of renewable and biodegradable, which is of significance for constructing a new industrial model of resource saving, environmental friendliness and recycling utilization and promoting the industrial upgrading of traditional artificial boards. In addition, the novel wallboard has great economic and social value for promoting China's wooden buildings to catch up with the advanced level of developed countries in the world.

### BRIEF DESCRIPTION OF THE DRAWINGS

FIG. 1 is a front view of a device for a method according to the present invention.

FIG. 2 is a structural view after molding plates and thickness gauges shown in FIG. 1 are removed.

FIG. 3 is a structural view after a punch, a bottom plate and reinforcing ribs shown in FIG. 1 are removed.

FIG. 4 is a structural view of a molding cavity shown in FIG. 1.

FIG. 5 is a left view of FIG. 1.

FIG. 6 is a left view of FIG. 2.

FIG. 7 is a left view of FIG. 3.

FIG. 8 is a top view of FIG. 1.

FIG. 9 is a top view of FIG. 2.

FIG. 10 is a top view of FIG. 3.

FIG. 11 is a front view of the punch.

FIG. 12 is a top view of FIG. 11.

FIG. 13 shows a connection relationship between the bottom plate and the reinforcing ribs.

FIG. 14 is a top view of FIG. 13.

FIG. 15 is a top view of FIG. 4.

FIG. 16 is a three-dimensional structural view of a reinforcing rib release mechanism.

FIG. 17 is a structural view of a tightening ring fixed at a bottom end of a reinforcing rib.

FIG. 18 is a first schematic view of an operating state (feeding wood/bamboo particles) of the device according to the present invention.

FIG. 19 is a second schematic view of an operating state (punching the wood/bamboo particles by the punch) of the method according to the present invention.

FIG. 20 is a left view of FIG. 18.

FIG. 21 is a front view of the device according to the present invention.

FIG. 22 is a right view of the device according to the present invention.

FIG. 23 is an S-S sectional view of FIG. 21.

FIG. 24 is a structural view after a feeding device shown in FIG. 21 is removed (the reinforcing ribs and inner molding tubes are omitted for clarity).

FIG. 25 is a three-dimensional structural view of a wood/bamboo molded hollowed board.

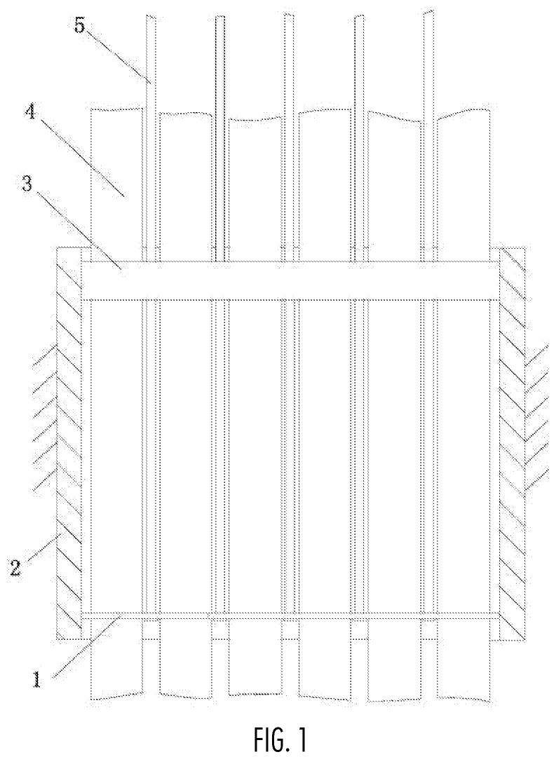

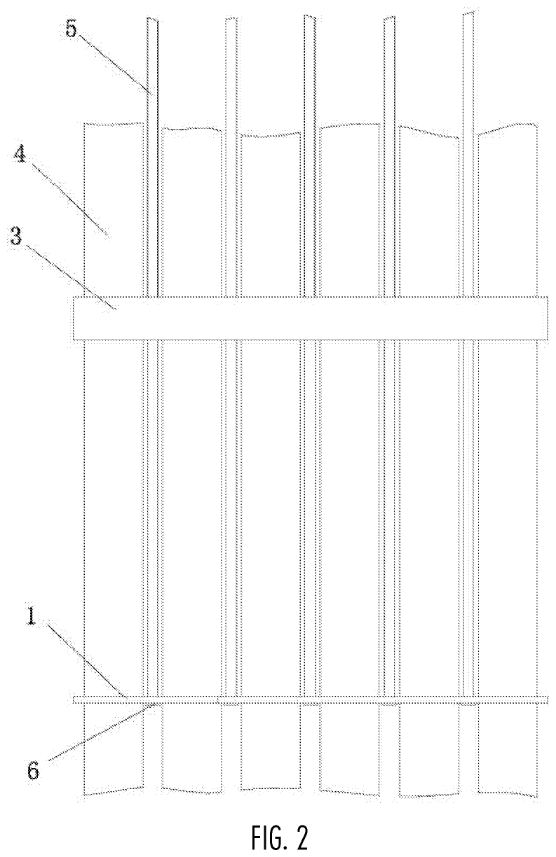

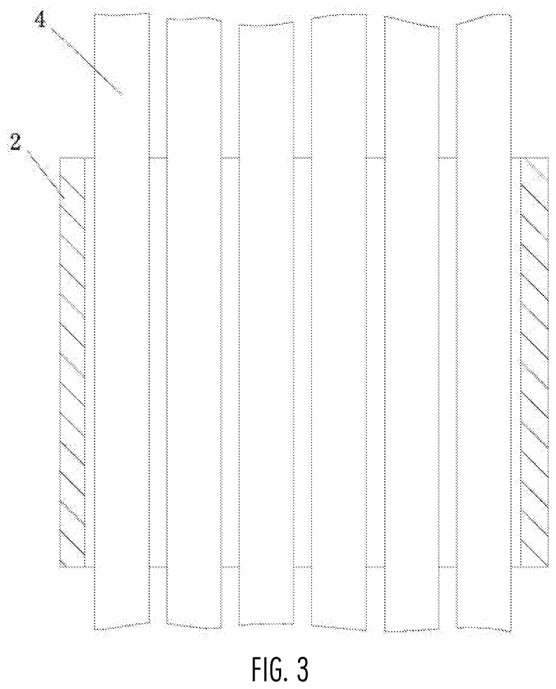

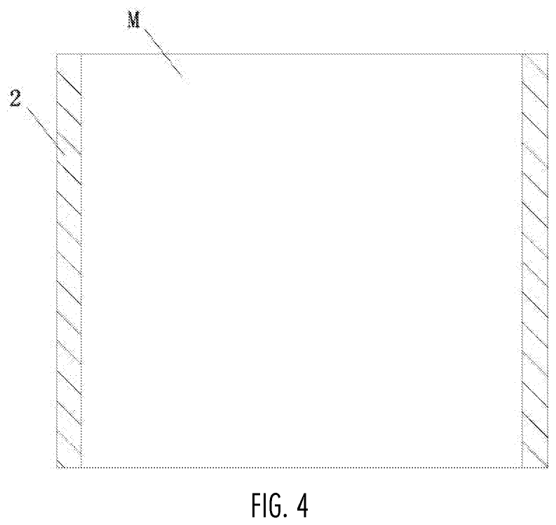

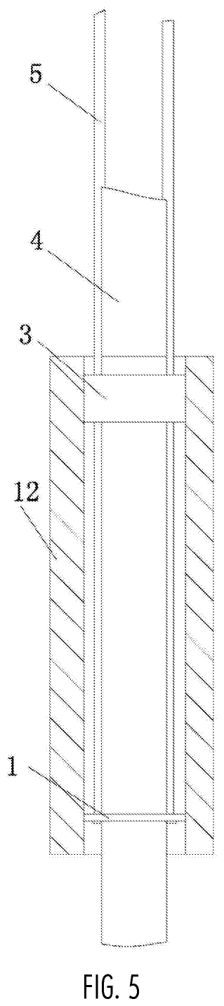

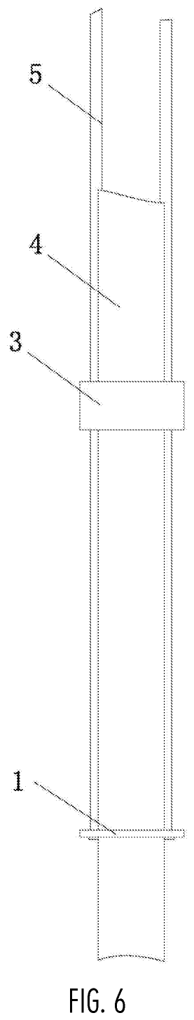

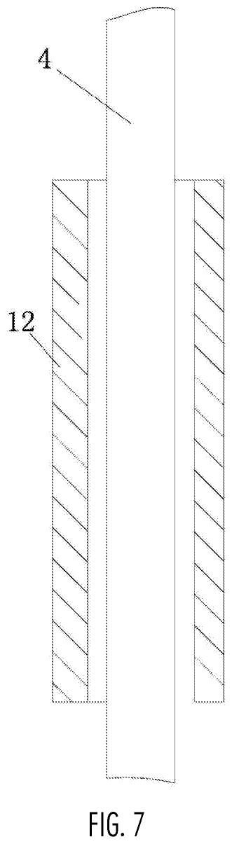

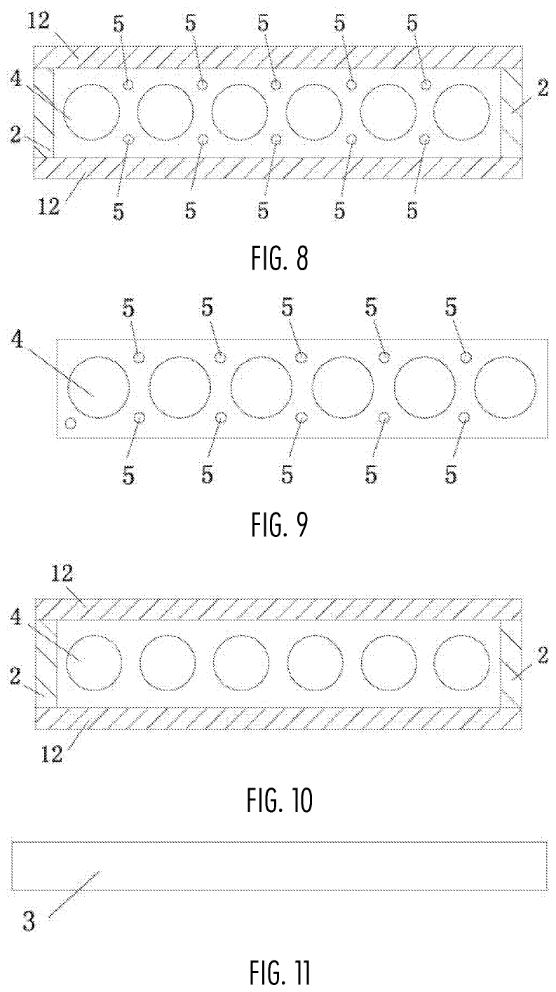

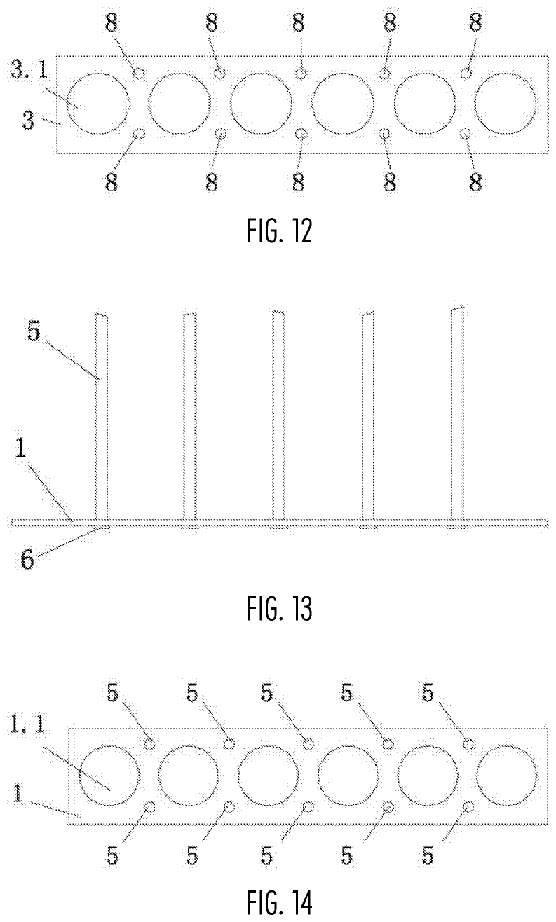

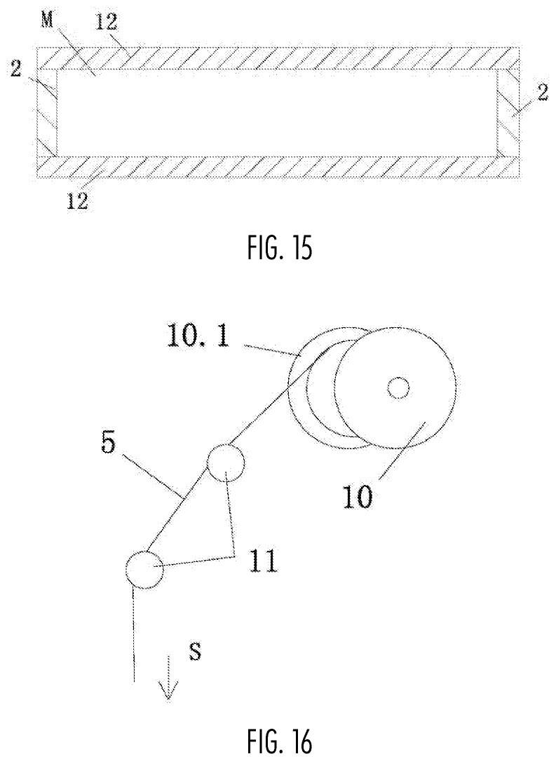

### DETAILED DESCRIPTION

The technical solutions of the present invention are described in further detail below with reference to the specific examples.

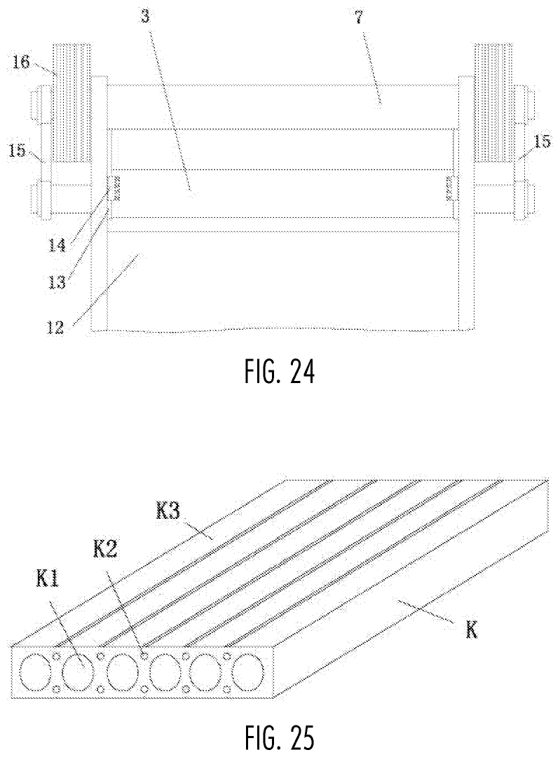

In the present invention, a wood/bamboo molded hollow wallboard K (as shown in FIG. 25) has a flat rectangular outer contour. The wallboard is provided with holes K1 that are arranged along a length direction and penetrate through both ends of wallboard in the length direction. The wallboard is further provided with a plurality of reinforcing ribs K2. The reinforcing ribs have an extension direction consistent with that of the holes. The reinforcing ribs are respectively provided between the holes and under an outer surface of the hollow board, so as to well bond to the hollow board.

At present, there are two methods for setting reinforcing ribs in the wood/bamboo hollow board. The first method is to define a plurality of holes during the molding of the wood/bamboo hollow board, penetrate reinforcing ribs into the holes after the molding is completed, and bond the reinforcing ribs by using an adhesive. The second method is to use a flat platen pressing method to prepare the molded hollow board, and place reinforcing ribs at the same time of molding, so as to achieve the purpose of improving the strength and dimensional stability of the board. These two methods are both secondary molding and intermittent production process, which have high cost and low production efficiency and cannot meet the requirements of architectural design specifications for product performance. To overcome these shortcomings, the present invention adopts a new design.

The present invention provides a method for continuously forming a wood/bamboo molded hollow wallboard with embedded reinforcing ribs, including the following steps:

1) Drive a punch by an actuating mechanism to move up and down in a molding cavity M along vertical guide rails, so that the punch moves relative to a plurality of inner molding tubes 4 and a plurality of reinforcing ribs 5 which are vertically provided in the molding cavity and are in a movable fit with the punch; allow a heating mechanism to heat a wall portion of the molding cavity and a wall of the inner molding tubes, where the vertical guide rails are provided on pillars on both sides of a frame; top ends of the plurality of inner molding tubes are fixed on a beam on an upper part of the frame.

The molding cavity is enclosed by two molding plates 12 keeping a parallel distance in a thickness direction of the cavity and two thickness gauges 2 provided at both ends of the cavity in a width direction; the molding cavity is provided with an opening on the top and at the bottom, respectively.

2) Move the punch upwards for a distance away from an upper opening of the molding cavity (as shown in FIG. 18) to open a top inlet (top feeding port) of the molding cavity; enable a feeding device to evenly feed a quantitative amount of wood/bamboo particles accompanied by glue into the molding cavity through the top inlet, where the wood/bamboo particles are supported by a bottom plate 1 after falling into the molding cavity.

3) Drive the punch by the actuating mechanism to move downwards and enter the molding cavity to punch the fed wood/bamboo particles, so that the wood/bamboo particles and the reinforcing ribs are combined tightly into a board blank to be heated in the molding cavity; form holes penetrating through the board blank from top to bottom by using the inner molding tubes; move the plurality of reinforcing ribs, the board blank and the bottom plate downwards synchronously for a certain distance (preferably 10-50 mm) under pressure, where the plurality of reinforcing ribs are evenly embedded in the board blank, and each reinforcing rib is kept at a distance from the holes and an outer surface of the board blank.

4) Move the punch upwards again for a distance away from the upper opening of the molding cavity to open the top inlet of the molding cavity again; enable the feeding device to evenly feed the wood/bamboo particles accompanied by the glue into the molding cavity through the top inlet, where the wood/bamboo particles are laid on an upper part of the board blank formed in the above step after falling into the molding cavity; allow the punch to punch the fed particles while the formed board blank is heated from outside to inside at high temperature by the inner wall of the molding cavity and the wall of the inner molding tubes, so that the glue quickly solidifies every time the board blank is subjected to mobile punching.

5) Repeat steps 3) and 4) to perform cyclic operations to obtain a continuously formed wood/bamboo molded hollow wallboard, gradually draw out the wood/bamboo molded hollow wallboard from the bottom of the molding plate, and cut according to a required length.

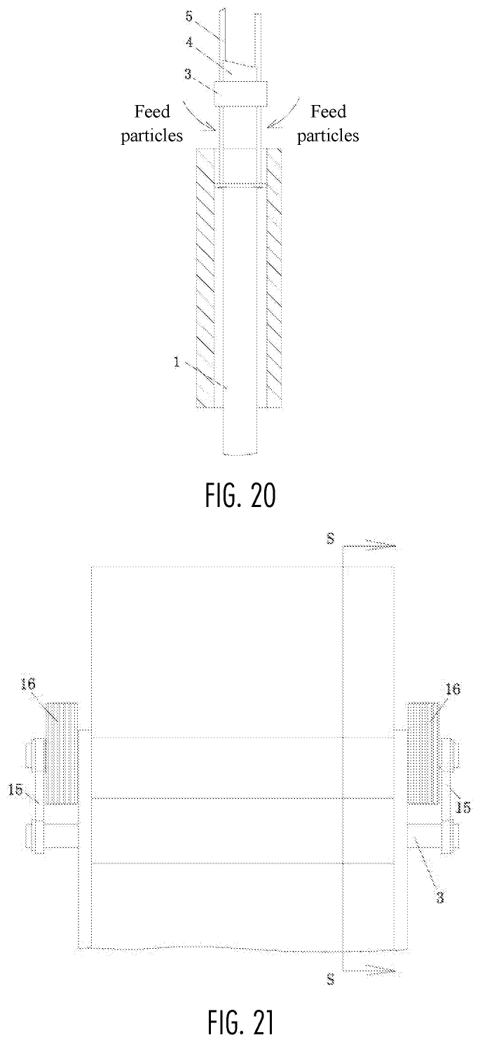

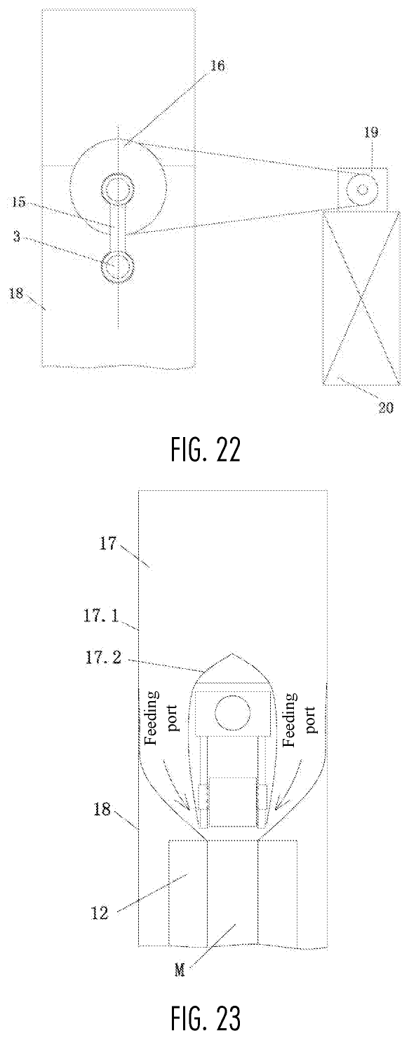

The present invention further provides a continuous forming device for a wood/bamboo molded hollow wallboard with embedded reinforcing ribs (as shown in FIGS. 21 to 24). Two molding plates 12 and two thickness gauges 2 are vertically fixedly provided on a frame 18 to enclose a vertical molding cavity M with a rectangular cross section. The molding cavity is provided with an opening on the top and at the bottom, respectively. The two molding plates keep a parallel distance in a thickness direction of the molding cavity. The two thickness gauges are provided at both ends of the molding cavity in a width direction to control the thickness of a finished wallboard. The rectangular cross section has the same contour as a cross section of the wood/bamboo molded hollow board. A plurality of cylindrical inner molding tubes 4 are arranged vertically in a straight line and fixed in the molding cavity for forming holes on the hollow wallboard. Upper ends of the inner molding tubes are fixed by a fixed beam 7 on the frame. The size of the inner molding tube and the arrangement among the adjacent inner molding tubes are the same as the holes of the ultra-thick thick wood/bamboo molded hollow wallboard

A punch 3 is provided horizontally and positioned in the molding cavity by moving up and down driven by an actuating mechanism The punch moves up and down in the molding cavity through a guide rail mechanism on pillars at both ends the frame. The guide rail mechanism includes a plurality of vertical guide rails 13 fixed on the pillars of the frame and a plurality of sliders 14 fixed on four corners at an outer periphery of the punch and in a slidable fit with the vertical guide rails. The punch is provided thereon with a plurality of sliding holes 3.1. The sliding holes are vertically arranged, and correspondingly sleeved on the inner molding tubes. A peripheral shape of the punch is adapted to the cross-sectional contour of the molding cavity, so as to avoid interfere in the mobile fit between the punch and an inner wall of the molding cavity. A heating mechanism is embedded in the molding plates and the inner molding tubes. The fixed beam above the punch fixes all the inner molding tubes. The inner molding tubes are double-layer tubes. Heat is input from an upper part of an inner tube of the inner molding tube, output from a lower part of the inner tube to an interlayer between inner and outer tubes, and then output from an upper part of the interlayer to form a heating cycle. In addition, the continuous forming device is provided with a feeding device 17 for feeding wood/bamboo particles to the molding cavity.

The above described is similar to the structure of the existing device for forming a wood/bamboo molded hollow board.

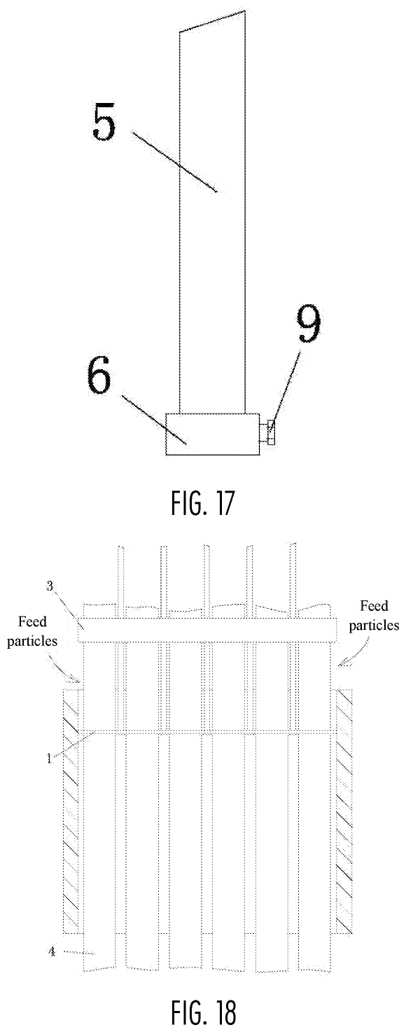

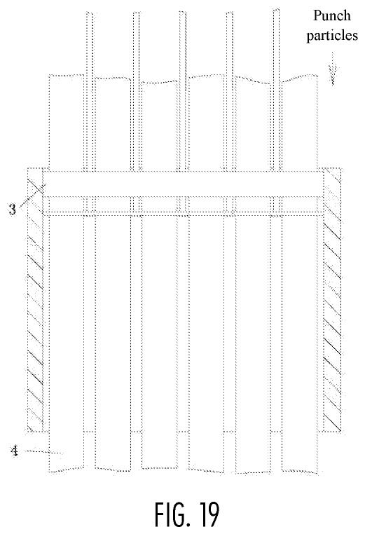

The present invention has made the following improvements. A horizontal bottom plate 1 is provided below a punch. A peripheral shape of the bottom plate is adapted to a cavity. The bottom plate is provided thereon with a plurality of sliding holes 1.1 corresponding to a plurality of inner molding tubes. The sliding holes are sleeved on the plurality of inner molding tubes to form a slidable fit with the inner molding tubes. The peripheral shape of the bottom plate is adapted to a cross-sectional contour of the cavity. The bottom plate and the punch are respectively provided thereon with a plurality of through holes. A plurality of reinforcing ribs 5 respectively pass through the through holes 8 on the punch from top to bottom, and then are fixed in the through holes of the bottom plate. FIGS. 13 and 17 show one of methods for fixing the reinforcing ribs. The reinforcing ribs pass downward through the through holes of the bottom plate, and then are fixed by a tightening ring 6. A tightening screw 9 on the tightening ring is tightened towards an inner diameter to press and fix the reinforcing ribs that pass through the tightening ring. Because a diameter of the tightening ring is larger than the through holes of the bottom plate, the reinforcing ribs cannot pass through the through holes of the bottom plate to move upwards, so that the reinforcing ribs are fixed on the bottom plate in a single direction. In this way, a punching force on the bottom plate is transferred to the reinforcing ribs.

The plurality of the reinforcing ribs are gradually released by a plurality of release mechanisms (conventional mechanisms) provided on the frame. Each release mechanism includes a spool 10 wound with one reinforcing rib, a damping mechanism for damping rotation of the spool and a plurality of guide wheels 11 for guiding movement of the reinforcing rib. The damping is performed to cause the reinforcing rib to produce a certain tension. As the simplest damping mechanism, a friction plate is fixed on the frame. One end of the friction plate is pressed against a flange 10.1 of the spool to generate friction. When the punch moves downward to punch the wood/bamboo particles, if the pressure on the bottom plate exceeds a damping force, the reinforcing rib is driven to move downward for a certain distance, that is, the reinforcing rib is naturally released for a certain distance. In this way, the reinforcing rib always maintains a certain tension.

An inner wall of the molding cavity is adapted to a surface structure of the wood/bamboo molded hollow wallboard. When the surface of the wood/bamboo molded hollow wallboard is designed with a plurality of longitudinal grooves K3, the wall of the cavity with a rectangular cross section is provided with corresponding protrusions. In this way, the wood/bamboo molded hollow wallboard obtained by the present invention has a surface decoration effect as designed.

The punch adopts a driving method that is prior art. It can be seen from the drawing that both ends of the punch extend out of the frame, and the punch is driven by an actuating mechanism provided on the frame. The actuating mechanism is a crank and slider mechanism driven by a motor 19 through a pulley mechanism. The crank is a connecting rod 15 eccentrically hinged on a punching flywheel 16. A bottom end of the connecting rod is hinged with an end of the punch to convert rotational kinetic energy of the punching flywheel into linear punching kinetic energy. In this way, the punch is driven to slide up and down along the vertical guide rails to punch the wood/bamboo particles fed into the molding cavity. In FIG. 24, a rotating shaft of the punching flywheel is shielded by the upper beam 7.

The reinforcing ribs are preferably flexible reinforcing ribs impregnated with thermosetting resin, which can be metal wire ropes, strong fiber wire ropes, especially aramid fiber reinforced ropes.

As shown in FIG. 23, the feeding device 17 includes an outer shell 17.1 and an inner shell 17.2. The outer shell 17.1 forms an outer wall of the feeding device, and the inner shell covers the punch to isolate the punch from the wood/bamboo particles. A funnel-shaped output port is formed between the outer shell and the inner shell. The output port is aligned with the top opening of the molding cavity. When the punch moves upwards to open the top inlet, the wood/bamboo particles is fed into the molding cavity. The amount of the wood/bamboo particles fed is determined by the size of the top inlet (determined by the distance the punch moves upwards).

What is claimed is:

1. A method for continuously forming a wood/bamboo molded hollow wallboard with embedded reinforcing ribs, comprising the following steps:
a) driving a punch in a molding cavity by an actuating mechanism to move up and down in a straight line along vertical guide rails, so that the punch moves relative to a plurality of inner molding tubes and a plurality of reinforcing ribs which are vertically provided in the molding cavity and are in a movable fit with the punch; allowing a heating mechanism to heat both an inner wall of the molding cavity and a wall of the inner molding tubes;
b) moving the punch upwards for a distance away from an upper opening on a molding plate to open a top inlet of the molding cavity; enabling a feeding device to evenly feed wood/bamboo particles accompanied by glue into the molding cavity through the top inlet, wherein the wood/bamboo particles are supported by a bottom plate after falling into the molding cavity;
c) driving the punch by the actuating mechanism to move downwards and enter the molding cavity to punch the fed wood/bamboo particles, so that the wood/bamboo particles and the reinforcing ribs are combined tightly into a board blank to be heated in the molding cavity; forming holes penetrating through the board blank from top to bottom by using the inner molding tubes; moving the board blank together with the bottom plate connected to the bottom of the reinforcing ribs downwards for a plurality of distances;
d) moving the punch upwards again for a distance away from the upper opening of the molding cavity to open the top inlet of the molding cavity again; enabling the feeding device to evenly feed the wood/bamboo particles accompanied by the glue into the molding cavity through the top inlet, wherein the wood/bamboo particles are laid on an upper part of the board blank formed in the above step after falling into the molding cavity; allowing the punch to punch the fed particles while the formed board blank is heated outside and inside simultaneously at high temperature by the wall of the molding cavity and the wall of the inner molding tubes, so that the glue can quickly solidifies every time the board blank is subjected to mobile punching;
e) repeating steps c) and d) to perform continuous cyclic operations, that is feeding, punching and heating the wood/bamboo particles to form a continuously formed board blank; gradually moving the board blank downwards out of the molding cavity, to obtain a finished wood/bamboo molded hollow wallboard.

2. The method for continuously forming a wood/bamboo molded hollow wallboard with embedded reinforcing ribs according to claim 1, wherein the molding cavity is enclosed by two molding plates keeping a distance in a thickness direction of the cavity and two thickness gauges provided at both ends of the cavity in a width direction; the molding cavity is provided with an opening on the top and at the bottom, respectively.

3. The method for continuously forming a wood/bamboo molded hollow wallboard with embedded reinforcing ribs according to claim 2, wherein the bottom plate is pulled by the plurality of reinforcing ribs; the plurality of reinforcing ribs are respectively released by a release mechanism provided at the top of a device, and then pass vertically downward through the punch to connect the bottom plate.

4. The method for continuously forming a wood/bamboo molded hollow wallboard with embedded reinforcing ribs according to claim 3, wherein the plurality of reinforcing ribs are evenly embedded in the board blank, and each reinforcing rib is kept at a distance from the holes and an outer surface of the board blank.

5. The method for continuously forming a wood/bamboo molded hollow wallboard with embedded reinforcing ribs according to claim 4, wherein top ends of the plurality of inner molding tubes are fixed on a beam on an upper part of the frame; the vertical guide rails are provided on an inner wall of pillars on two ends of the frame.

6. The method for continuously forming a wood/bamboo molded hollow wallboard with embedded reinforcing ribs according to claim 5, wherein the actuating mechanism is a crank and slider mechanism driven by a motor through a pulley mechanism; the crank is a connecting rod eccentrically hinged on a punching flywheel.

7. A device for continuously forming a wood/bamboo molded hollow wallboard with embedded reinforcing ribs, comprising a molding cavity, a plurality of inner molding tubes and a punch, wherein the molding cavity is provided vertically, and has a rectangular cross section; the molding cavity is provided with an opening on the top and at the bottom, respectively; the plurality of inner molding tubes are vertically arranged in a straight line in the molding cavity; top ends of the inner molding tubes are fixed on a frame on an upper part of a frame; the punch is adapted to a shape of the cross section of the molding cavity, and is able to be driven by an actuating mechanism to move up and down in the molding cavity; the molding cavity is enclosed by two molding plates keeping a parallel distance in a thickness direction of the cavity and two thickness gauges provided at both sides of the cavity in a width direction; the punch is in a movable fit with the inner molding tubes through a plurality of sliding holes vertically provided thereon; a heating system is embedded in the molding plates and the inner molding tubes; the frame is further provided with a feeding device for feeding wood/bamboo particles into the molding cavity;
a bottom plate is further horizontally provided under the punch; the bottom plate is able to move up and down in the molding cavity; a peripheral shape of the bottom plate is adapted to the cross-sectional shape of the molding cavity; the bottom plate is provided with a plurality of sliding holes that are in a slidable fit with the inner molding tubes; the bottom plate and the punch are respectively provided with a plurality of through holes; the plurality of reinforcing ribs pass through the through holes on the punch from top to bottom, and then are fixed on the bottom plate in a single direction;
the plurality of reinforcing ribs are respectively gradually released by a release mechanism provided on the top of the frame.

8. The device for continuously forming a wood/bamboo molded hollow wallboard with embedded reinforcing ribs according to claim 7, wherein a wall surface of the molding cavity is provided with a plurality of vertical protrusions, which correspond to grooves on a surface of the wood/bamboo molded hollow wallboard to increase a surface decoration effect of the wood/bamboo molded hollow wallboard.

9. The device for continuously forming a wood/bamboo molded hollow wallboard with embedded reinforcing ribs according to claim 8, wherein two ends of the punch are vertically slidably positioned on pillars on the frame through a vertical guide rail mechanism; the guide rail mechanism comprises a plurality of vertical guide rails provided on the pillars at two sides of the frame and a plurality of sliders fixed on a periphery of the punch and fit with the vertical guide rails.

10. The device for continuously forming a wood/bamboo molded hollow wallboard with embedded reinforcing ribs according to claim 9, wherein two ends of the punch in a length direction respectively extend out of the frame to hinge with a bottom end of a connecting rod that is eccentrically hinged on a punching flywheel; thus, rotational kinetic energy is converted into linear punching kinetic energy to punch the wood/bamboo particles fed into the molding cavity.
